(19) United States
(12) Patent Application Publication
(10) Pub. No.: US 2016/0371097 A1
(43) Pub. Date: Dec. 22, 2016

(54) Air Gapping / Offboarding of Software

(71) Applicant: Joshua Clay Magee, Point of Rocks, MD (US)

(72) Inventor: Joshua Clay Magee, Point of Rocks, MD (US)

(21) Appl. No.: 14/745,383

(22) Filed: Jun. 20, 2015

(51) Int. Cl. G06F 9/44; G06F 9/45

(52) U.S. Cl. CPC G06F 9/4408; G06F 8/41

(57) ABSTRACT

The invention is to provide an ‘air gap’ or ‘offboarding’ of the administrative functions/software that are available on any device that contains a built in web server that allows the user to configure the device via a web browser. Removal of the administrative software from the main board to an external data holding source, such as a USB device (internal/external), memory card, or separate disk housed within the device. Removal of the administrative software removes the attack vector, providing protection regardless of patch updates or any future advanced attack methods. The offboarded administrative tools are accessible by manual reconnection of the storage device or automated relays via an alternative method such as a snmp activation. The storage device can detach itself manually or by automated timer circuits that can be set for a desired time.

### CROSS-REFERENCE TO RELATED APPLICATIONS

To support the uniqueness and novel concept of the air gapping/offboarding of software as described in claim 1, a review of existing software that allows for modification of the embedded operating systems will detailed below.

Firmware Modification Kit: This software allows the decompilation of the DD-WRT firmware, thus allowing users to modify the operating system files to extend the capabilities or trim the services of the DD-WRT system. Per the DD-WRT Development site, listed “features include: add initialization scripts, install new packages, extend web UI, remove un-needed packages, mix-and-match packages from various DD-WRT variants” for more information see http://www.dd-wrt.com/wiki/index.php/Development. As noted modifying the firmware is not novel, but the invention/concept/process proposed in this document (claim 1) is unique in that, it seeks not only to remove a primary method for configuration the web interface, but places onto an off board data storage device for use.

OTRW2 (Optware the right way Take 2): This software seeks to greatly enhance the software capability of a standard DD-WRT operating system and the hardware limitation of wireless routers. In that it places a lot of robust software onto a USB stick, because the storage capacity is much larger than the internal vendor supplied storage containers. For more information see http://www.dd-wrt.com/wiki/index.php/OTRW2_(Optware_the_right_way_Take_2). Of importance, there is work showing the use of enhanced web servers (LAMP and others) provided by Optware running from the USB stick, but no examples of removing the stock web server and running administrative functions off the USB stick, focusing only on traditional web server services like captive portals. But what is novel about the invention, process, concept proposed in this document (claim 1) is that it does not seek to run additional web servers nor extend the capability of the existing server built into DD-WRT, but to fully remove the built in DD-WRT admin web server and relocate it to run from the USB stick. The prototype in claim 1 does not utilize Optware.

Modifying or rebranding of the DD-WRT web server files is not new either. As seen here http://hackaday.com/tag/dd-wrt/, there are many internet sources that describe the process of rebranding or modification. But what is novel about the invention, process, concept proposed in claim 1 is that it does not seek to rebrand or modify the software, but to remove the web server and web files.

Another area of interest is in extending the capabilities of the built in web server in DD-WRT as seen at http://www.dd-wrt.com/wiki/index.php/WEB_server. This method is to extend and does not discuss removal of the web server.

Due diligence has been conducted in searching patent and research databases for similar designs or concepts. Thorough searches within ProQuest, EBSCO Host, IEEE Xplore, Google Patent Database have been conducted as well as the Internet (about 400 webpages). Using the following keywords: “air gap” software, offboard software, “embedded devices” AND security AND external storage AND USB, “embedded device” AND “portable applications” AND USB. The searches yielded no designs, concepts, process, discussion or prototypes that would jeopardize the uniqueness of the invention in claim 1.

### THIS INVENTION OF CONCEPT, PROCESS AND PROTOTYPE IS NOT FEDERALLY SPONSORED RESEARCH OR DEVELOPMENT

### THIS IS A NON-JOINT RESEARCH INVENTION, ONLY A SINGLE INVENTOR, MYSELF

### NO INFORMATION IS REFERENCE TO A CD-ROM. ALL DETAILED SEQUENCE LISTING IS PROVIDED IN THE DETAILED DESCRIPTION SECTION OF THIS DOCUMENT

### THERE ARE NO PRIOR DISCLOSURES BY THIS INVENTOR

### BACKGROUND OF THE INVENTION

The presentation of this invention is to provide the field of information security a novel method of enhancing the security posture of IP enabled devices and the network enterprise at large. To introduce the concept (and method of doing so via a prototype) of air gapping software or offboarding software.

Current methods of exploitation within the cyber domain are executed through the use of IP enabled devices that utilize a web server to provide web based administrative configurations.

Devices such as home automation devices, SCADA/ICS, webcams, IP phones, network printers, network storage devices, routers, firewalls, switches, Internet of Things and other devices classified as network infrastructure devices all utilize an internally/embedded based web server, the purpose of which is to increase the ease of configuration. These web based administrative consoles receive rare use after the initial use of configuring a device. Thus leaving this easy attack vector from being exploited by an ever advancing skillset of IT security threats. What was once secure enough for 2003, no longer is able to maintain that level of security in light of attacker skills and threats of 2015.

Additionally, the web server is often regarded as being the low hanging fruit to the exploitation of a device and subsequently the internal network, these web servers are often simple, providing limited functionality and robustness to only provide administrative capabilities. For instance, an IP phone's purpose is to be a phone not a web server, when vendors update or issue patches it is often to enhance its primary function, being a better phone or enhancing the security vulnerabilities of the phones function, not the administrative web based console. Thus administrative tools such as the embedded web server, telnet, ssh applications are often over looked. In addition, devices may long outlive their vendors and their support in patches, often for economic reasons, these devices that function properly are left in place, but lack the vendor support for updates and patches. Leaving these devices exploitable to future evolutions in attacker skills and other threats. Removing the administrative tool, as proposed in this invention, by relocating the onboard http web server and its associated files to an offboard storage source, will effectively remove the point of entry. This software based “air gap” solution and concept will enhance their security posture of these devices without the need or vendor support or if exploitation methods not yet discovered will still provide a strong measure of security. 100% security is achieved when the air gap is created and only susceptible during times of use. The air gap can be automatically disengaged through the use of timer circuit relays/switches or manually toggle/dip switches or simply unplugged.

The discussion above is merely provided for general background information and is not intended to be used as an aid in determining the scope of the claimed subject matter.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A software based air gap or offboarding method is provided utilizing software modifications paired with hardware modifications for enhancing the security of IP enabled devices, primarily securing the ‘always on/available’ capability but rarely used administrative tools used in the configuration of the device. The method includes the steps for preparing the external data storage device, the retrieval and transfer of the administrative tools from the device to the external data storage device, the extraction/decompiling of the firmware, making appropriate changes to the operating system located in the firmware, recompiling the firmware, loading the custom firmware, providing initial one time configuration to enable the external data storage device usage and testing/verification of operability.

### BRIEF DESCRIPTION THE DRAWINGS

The solution will now be described in more detail by means of exemplary embodiments and with reference to the accompanying drawings, in which:

FIG. 1 shows the USB stick partition assessment.

FIG. 2 shows the USB Delete Partition process.

FIG. 3 shows the USB apply button.

FIG. 4 shows the USB partition type status.

FIG. 5 shows the USB create partition.

FIG. 6 shows the USB partition creation parameters.

FIG. 7 shows the USB New partition status.

FIG. 8 shows the manual IP configuration using Microsoft Windows.

FIG. 9 shows the Asus Web Configuration Console.

FIG. 10 shows the Asus firmware upgrade.

FIG. 11 shows the DD-WRT (mini) password change.

FIG. 12 shows the DD-WRT (mini) firmware upgrade process.

FIG. 13 shows the DD-WRT (mini) firmware upgrade.

FIG. 14 shows the DD-WRT (big) password change.

FIG. 15 shows the SSH enable procedure.

FIG. 16 shows the SSH Apply settings.

FIG. 17 shows the USB Support activation.

FIG. 18 shows the retrieving current USB settings from nvram process.

FIG. 19 shows the verifying /opt/ directory (USB stick) is empty process.

FIG. 20 shows the USB: Copying of www file to the USB stick mounted to /opt/ process.

FIG. 21 shows the USB: Copying of httpd file to the USB stick mounted to /opt/ process.

FIG. 22 shows the Firmware Mod Kit: Downloading and installing prerequisite files and FMK software.

FIG. 23 shows the Firmware Mod Kit install completion and verification process.

FIG. 24 shows the downloading firmware and renaming process.

FIG. 25 shows the extracting the operating system from the .bin firmware file process.

FIG. 26 shows the verification of the extraction process.

FIG. 27 shows the Httpd: Removing the web server and creating the symlink process.

FIG. 28 shows the www: Removing the web binary blob file and creating the symlink process.

FIG. 29 shows the rebuilding the new modified firmware file process.

FIG. 30 shows the prepping the upgrade of the Offboarding Custom firmware process.

FIG. 31 shows the upgrading the firmware progress screen.

FIG. 32 shows the Ping status of the router during the upgrade process.

FIG. 33 shows the Telnet: Putty.exe settings.

FIG. 34 shows the logging into the custom DD-WRT using telnet process.

FIG. 35 shows the verification of the http settings within the nvram configuration file.

FIG. 36 shows the verification that the httpd process is not running.

FIG. 37 shows the Telnet: Putty.exe settings.

FIG. 38 shows the manual start of the httpd service and verification the service will not start process.

FIG. 39 shows the verification that the httpd service is not running.

FIG. 40 shows the verifying that the ‘opt’ directory is empty.

FIG. 41 shows the verifying the presence of the symlink for the www (binary blob) file.

FIG. 42 shows the verifying the presence of the symlink for the httpd (web server) file.

FIG. 43 shows the verifying USB settings are inactive.

FIG. 44 shows the setting the USB variables, saving the settings and rebooting the router.

FIG. 45 shows the verification of the httpd process is running.

FIG. 46 shows the verification of a working Administrative Web Console.

FIG. 47 shows the verifying the computer's wireless adapter sees the current SSID config.d in the router.

FIG. 48 shows the verification that custom firmware is able to take and save changes.

FIG. 49 depicts two operational models of the invention.

FIG. 49 illustrates a real world wireless router with a USB stick disconnected, this state of the equipment will yield no administrative web gui. The web gui and server that is typically on the router, has been moved to the USB stick. The device, through modifications of the firmware, believes the software is there but does not fault out when it cannot find it. When the USB is plugged in the router's operating system has been modified to look for the software on the USB and will automatically mount the USB and the internal httpd server will run. When the user or administrator has completed configurations of the device, simply unplug it and the entire web architecture is gone, thus removing any potential web based security vulnerabilities.

This method of engaging and disengaging the web server files via the USB or any data storage device, can be conducted using toggle switches, timer based automatic circuit relays, software based timers or any other method to break the connection between the data storage device.

As most embedded IP enabled devices have room within the housing, the data storage device could be housed inside, with only the toggle switch exposed to the outside for enabling or disabling administrative functions.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “coupled” and variations thereof are used broadly and encompass both direct and indirect connections and couplings. Further, “connected” and “coupled” are not restricted to physical or mechanical connections or couplings.

In the description that follows, the prototype utilizes the following:

Asus RT-N16 Wireless Router: The IP enabled device to be modified to use air gapped software.

USB Stick: The offboarding data storage device that will connect to the Asus RT-N16 Wireless Router.

IP Enabled device (Wireless Router) and USB stick (data storage device) are the only two items that are needed for the concept/process of air gapping/offboarding to be operational.

The follow technologies aid in the preparatory work needed to allow the IP enabled device to communicate to the data storage device.

Windows Operating System (Win 10): Used as the workbench to format the USB stick, connect to wireless router, load the firmware and configure the system.

Linux Operating System (Kali Distro): Used to extract the files within the firmware, modifying the files and rebuild the firmware.

Firmware Mod Kit: Software used to decompile and extract the files within the DD-WRT firmware and to rebuild the modifying operating system back into the firmware state. https://code.google.com/p/firmware-mod-kit/wiki/Documentation

EaseUS Partition Magic Free Edition: Used to format the USB using the EXT2 filesystem in Windows 10. If a Linux system is available, then the operations this software does is not needed, as Linux is capable of doing this operation. http://www.easeus.com/

Putty and WinSCP: Software utilized to connect via telnet/SSH to interact with the modified operating systems of the wireless router.

DD-WRT Firmware: Utilized in replacing the Asus stock vendor firmware with an embedded Linux operating system, this operating system is to be modified in order to achieve the operability of the invention. http://dd-wrt.com/site/index

Embodiments of the invention, for example, may be implemented using proprietary firmware for proprietary IP enabled devices, IP enabled device based on Linux, Embedded Linux, Microsoft OSes and Embedded versions, as well any operating system not listed here. This prototype utilizes open-source technologies to showcase the prototypes set up and operation, but air gapping software can be accomplished using other operating systems and proprietary systems.

The full procedure is demonstrated with the instruction set below.

1. Prepare USB Stick:

Note: If you have a Linux computer then all that is needed is to format a USB stick as EXT2 file system.

Note: The USB stick needs to be a minimum of 3 MB, as the files are roughly 2 MB. But any larger capacity stick will work. Your EXT2 partition can be as small as 3 MB or as large the entire size of the USB Stick.

Step 1:

Plug in the USB stick into a Microsoft Windows computer (Windows 10 was used in this procedure).

Step 2:

Run EaseUS Partition Master Free Edition software

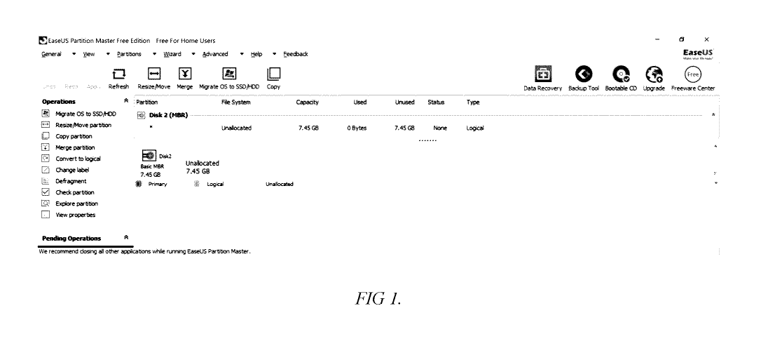

### FIG. 1. USB Stick Partition Assessment

If the USB drive (in this case Disk 2) is showing a file system like NTFS or something other than Unallocated, refer to FIG. 1. Proceed with the following instructions:

Step 3:

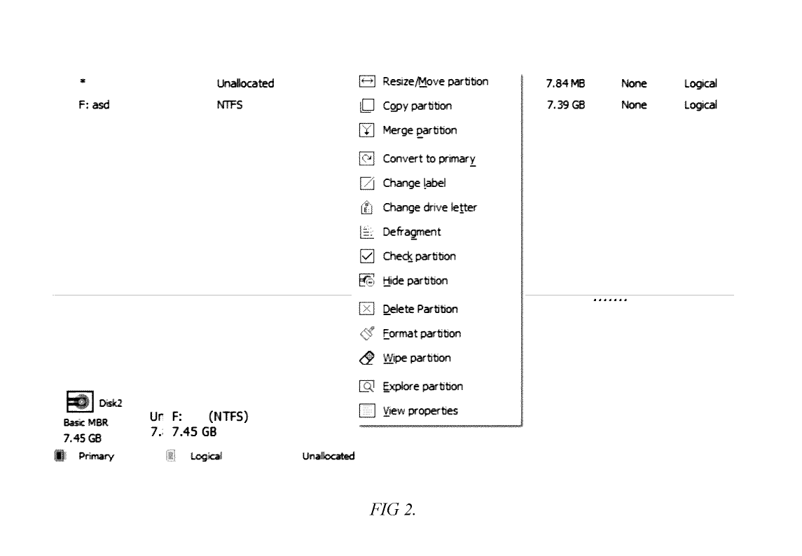

Right-click on the Disk 2-F: (NTFS) and select the Delete Partition item. As seen below in FIG. 2.

### FIG. 2. USB Delete Partition

Step 4:

Click the Apply Button:

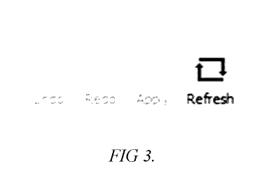

### FIG. 3. USB Apply Button

The USB drive should now show Unallocated for the entire space of the USB stick.

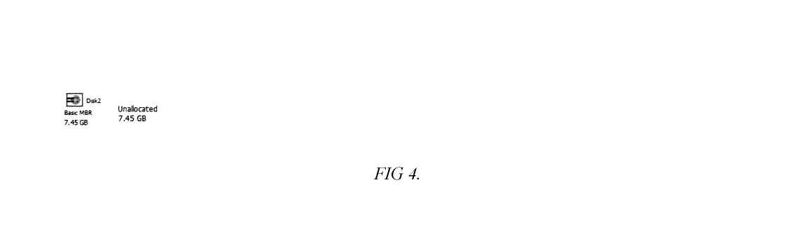

### FIG. 4. USB Partition Type Status

Step 5:

Right-click on the unallocated section and select Create Partition as seen below:

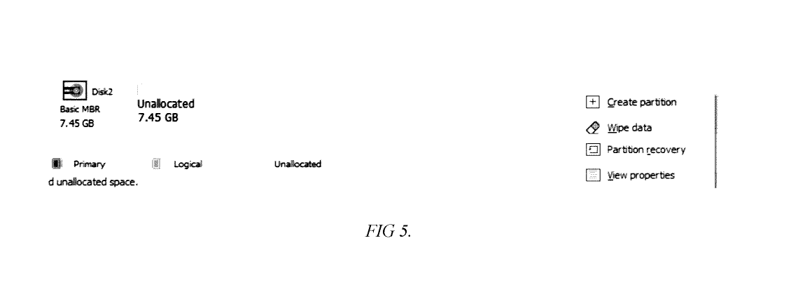

### FIG. 5. USB Create Partition

Step 6:

The USB stick will be need to be formatted and partitioned using the EXT2 file system using the settings shown below.

I chose 50 MBs as my partition size, but again one can scale down or up.

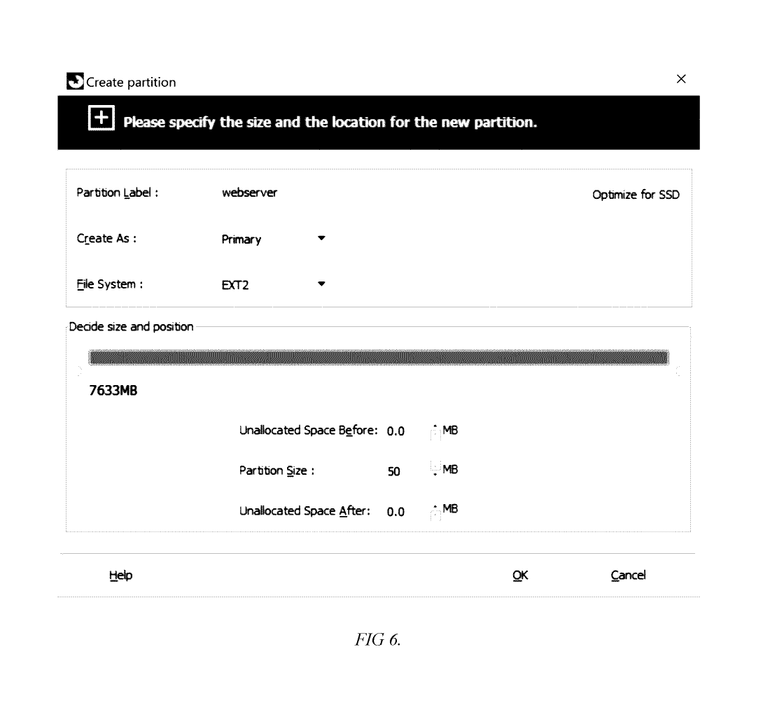

### FIG. 6. USB Partition Creation Parameters

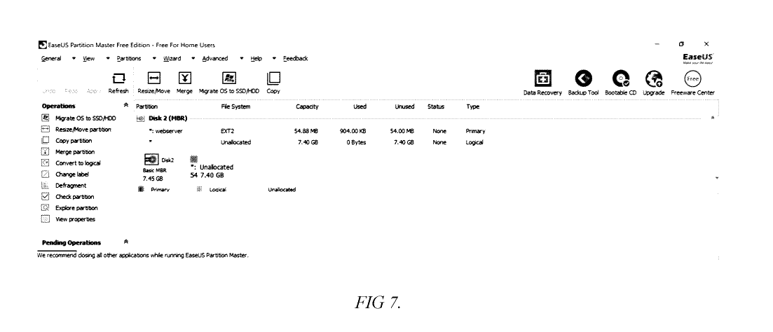

When formatting is completed the status of the USB stick will be as shown in FIG. 7.

### FIG. 7. USB New Partition Status

The USB should now be formatted as EXT2 and this portion of the procedure is complete.

1. Replacing Asus Wireless RT-N16 Stock Firmware:

Step 1:

Power up the Asus Wireless RT N-16 Wireless Router.

Step 2:

Connect a computer to the Asus Wireless RT-N16 Router using a LAN cable to any of the LAN ports on the back of the Asus Wireless RT-N16 Router.

Step 3.

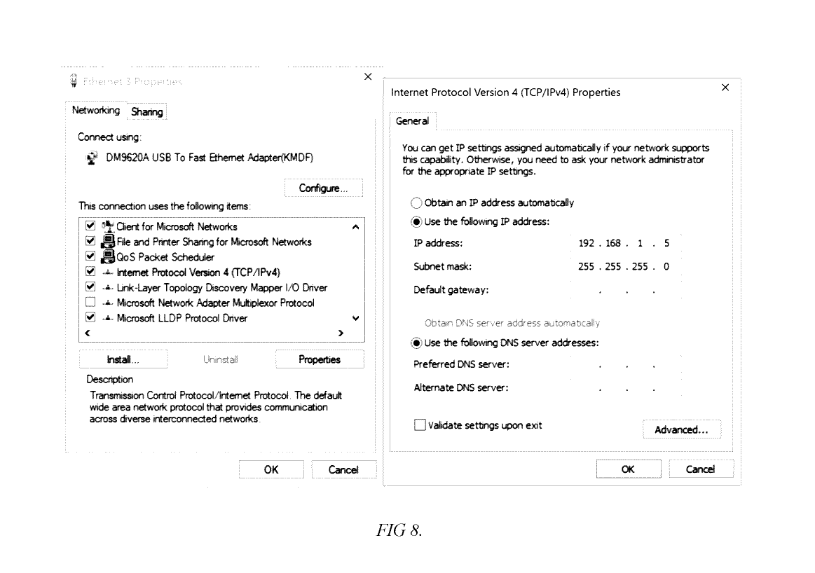

Manually set the IP of the computer to 192.168.1.5 and subnet of 255.255.255.0 as seen in FIG. 8.

### FIG. 8. Manual IP Configuration using Microsoft Windows

Step 4:

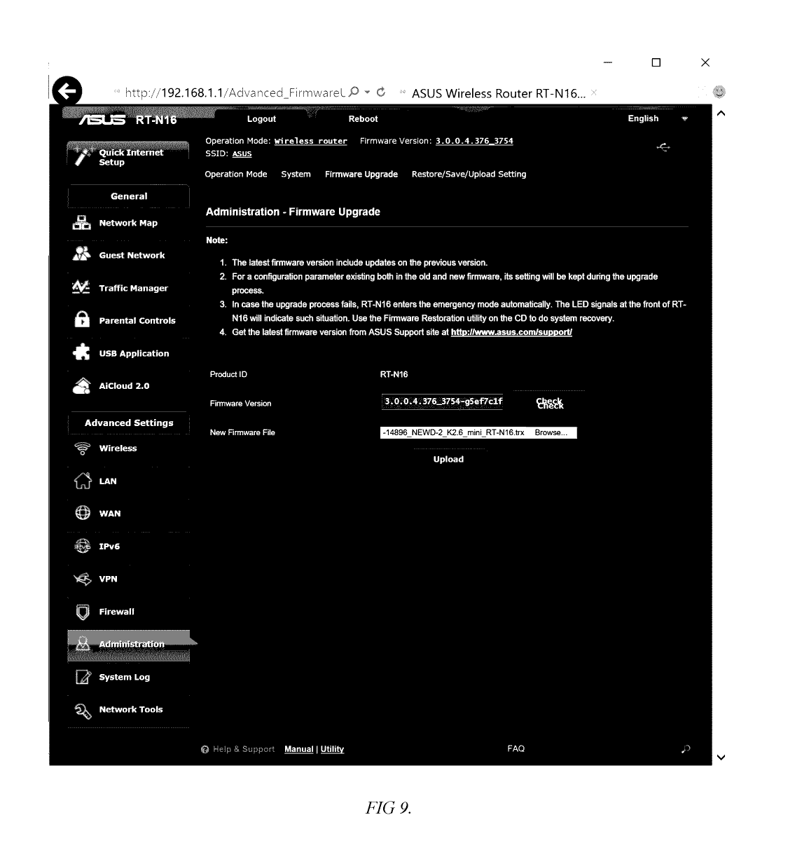

### Refer to FIG. 9 for the Following Sub Steps

4.1: Start up the web browser and put in the default IP of the Asus RT-N16 Wireless Router as HTTP://192.168.1.1.
4.2: Locate the ‘Administration’ Menu item on the left hand menu under Advanced Settings, click the ‘Administration’ Menu Button.
4.3: Locate the ‘Firmware Upgrade’ Tab on the field to the right of the side menu. Click the ‘Firmware Upgrade’ Tab.
4.4: Using another Browser (or tab), download the mini DD-WRT Firmware, dd-wrt.v24-14896_NEWD-2_K2.6_mini_RT-N16.trx, from
http://www.dd-wrt.com/routerdb/de/download/Asus/RT-N16/-/dd-wrt.v24-14896_NEWD-2_K2.6_mini_RT-N16.trx/3763
Save this file to the computer's desktop. This firmware is the primer Firmware (mini), which will be replaced by a more robust full Firmware (big).
4.5: Referring back to the Asus RT-N16 Wireless Router ‘Firmware Upgrade’ Tab, at the selection ‘New Firmware File’, click the ‘Browse’ button and select the firmware that was downloaded to the desktop.
4.6: Press the ‘Upload’ Button.

### FIG. 9. Asus Web Configuration Console

Step 5:

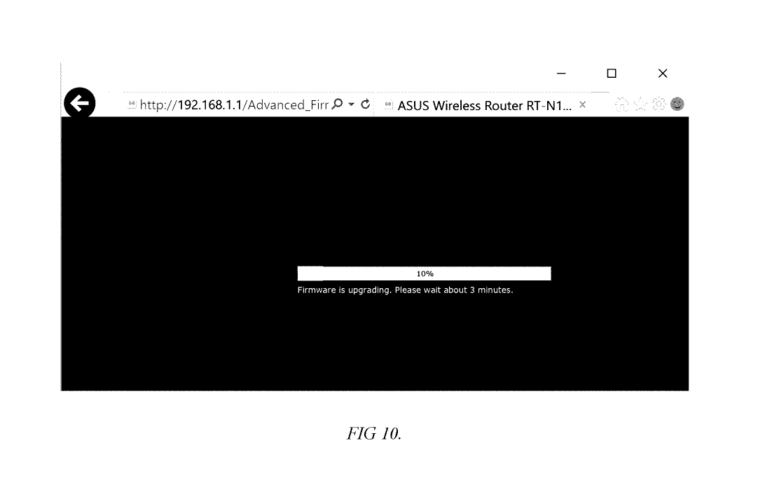

After clicking the Upload button, the firmware upgrading process will commence as noted in the FIG. 10.

### FIG. 10. Asus Firmware Upgrade

Step 6:

After the upgrading process is complete, refresh the browser. Upon doing so will bring up the initial configuration homepage of DD-WRT (mini), the new primer firmware that replaced the Asus Vendor Firmware.

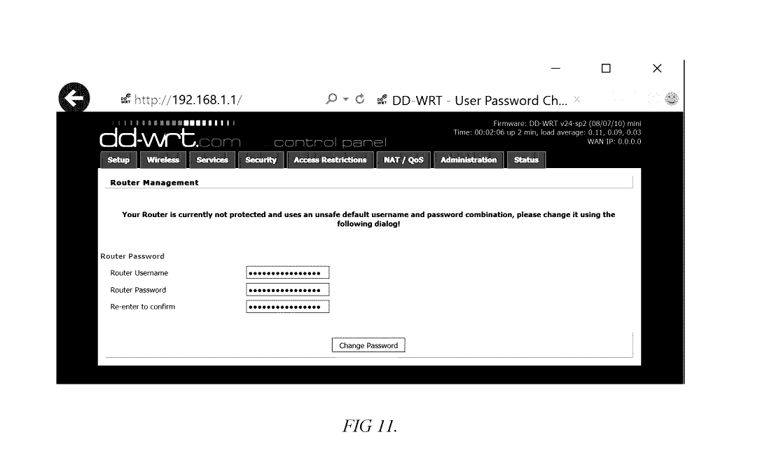

6.1: Create a user name (admin) and password. Click the ‘Change Password’ button as seen in FIG. 11.

### FIG. 11. DD-WRT (Mini) Password Change

Step 7:

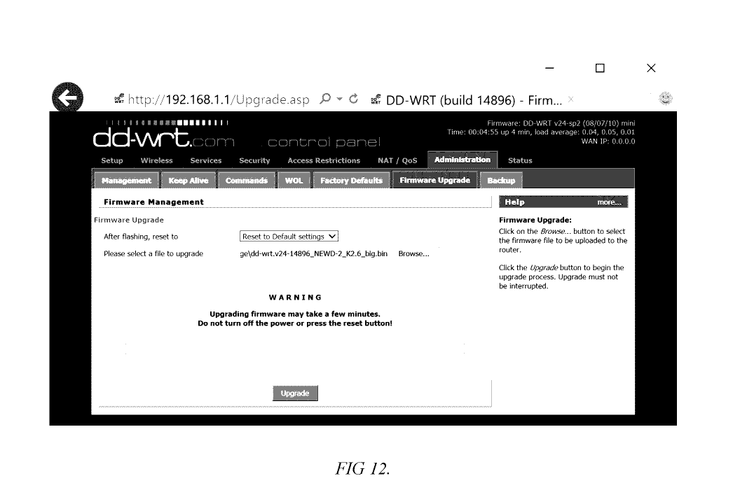

### Refer to FIG. 12 for the Following Sub Steps

7.1: Locate the ‘Administration’ Tab. Click the ‘Administration’ Tab.

7.2: Locate the ‘Firmware Upgrade’ Tab. Click the ‘Firmware Upgrade’ Tab.

7.3: Using another Browser (or tab), download the full DD-WRT Firmware, d-wrt.v24-14896_NEWD-2_K2.6_big.bin, from

http://www.dd-wrt.com/routerdb/de/download/Asus/RT-N16/-/dd-wrt.v24-14896_NEWD-2_K2.6_big.bin/3764

Save this file to the computer's desktop. This firmware is the full Firmware (big).

7.4: Referring back to the DD-WRT Control Panel Web Page, ‘Firmware Upgrade’ Tab.

7.4.1: At the Selection “After flashing, reset to” pull down menu, ensure that the selection is set to “Reset to Default settings:

7.4.2: Click the ‘Browse’ button and select the firmware (big) that was downloaded to the desktop, d-wrt.v24-14896_NEWD-2_K2.6_big.bin.

7.5: Press the ‘Upgrade’ Button.

### FIG. 12. DD-WRT (Mini) Firmware Upgrade Process

Step 8:

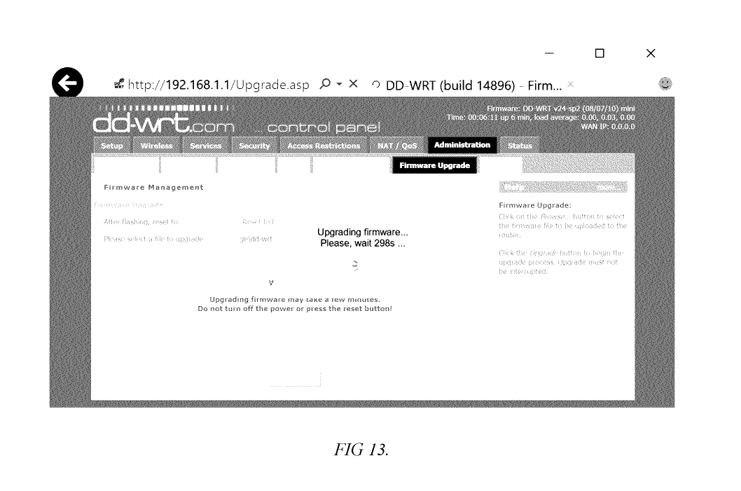

Upon pressing the ‘Upgrade’ button the new full firmware (big) will be loaded and replacing the Mini DD-WRT Firmware as seen in FIG. 13, several minutes are required to complete the process.

### FIG. 13. DD-WRT (Mini) Firmware Upgrade

Step 9:

After the upgrading process is complete, refresh the browser. Upon doing so will bring up the initial configuration homepage of DD-WRT (big), the Full firmware that replaced the Mini primer DD-WRT Firmware.

9.1: Create a user name (admin) and password. Click the ‘Change Password’ button.

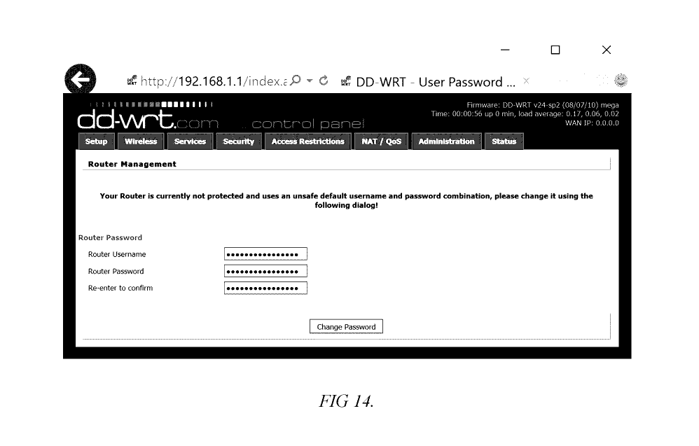

### FIG. 14. DD-WRT (Big) Password Change

Step 10:

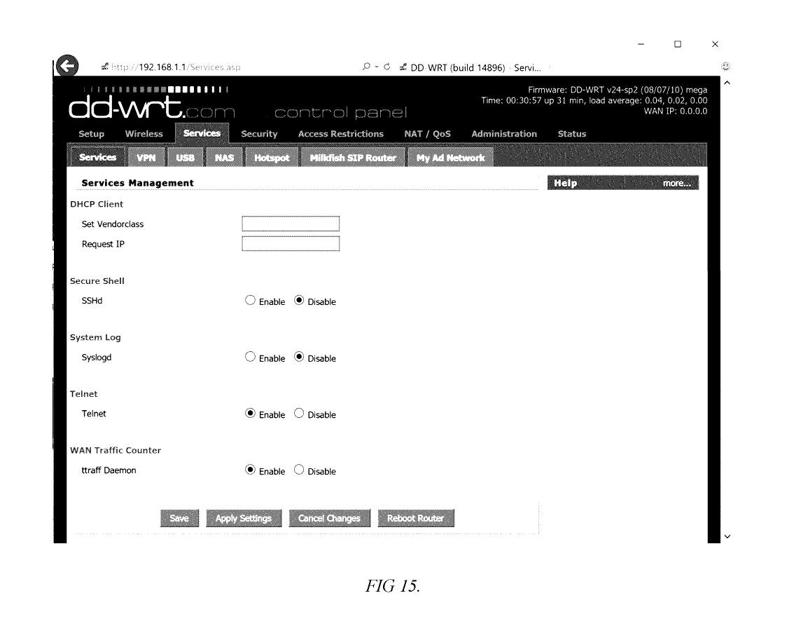

### Refer to FIG. 15 for the Following Sub Steps

SSH is not enabled by default, the following process will enable the SSH service on the DD-WRT router.

10.1: Locate and press the ‘Services’ Tab.

10.2: Scroll down the page and locate the ‘Secure Shell’ field. Click the ‘Enable’ radio button

### FIG. 15. SSH Enable Procedure

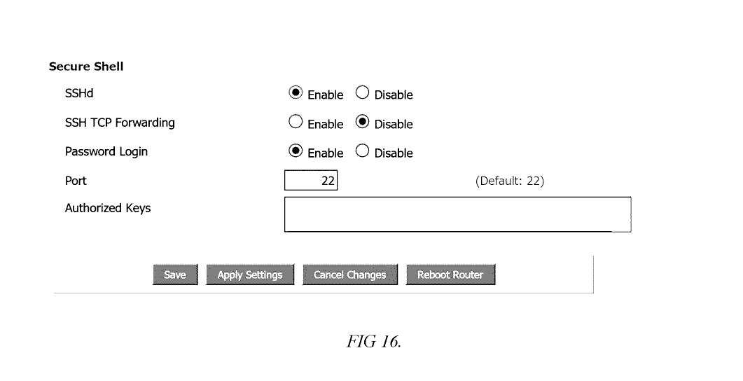

10.3: Upon selecting the ‘Enable’ Radio Button, the area will expand, as seen in FIG. 16. No action is needed, as the default selections are suitable. Click the ‘Apply Settings’ Button.

### FIG. 16. SSH Apply Settings

Step 11:

USB Support is not enabled by default, the following process will enable the USB service on the DD-WRT router.

11.1: Locate and click the ‘USB’ tab.

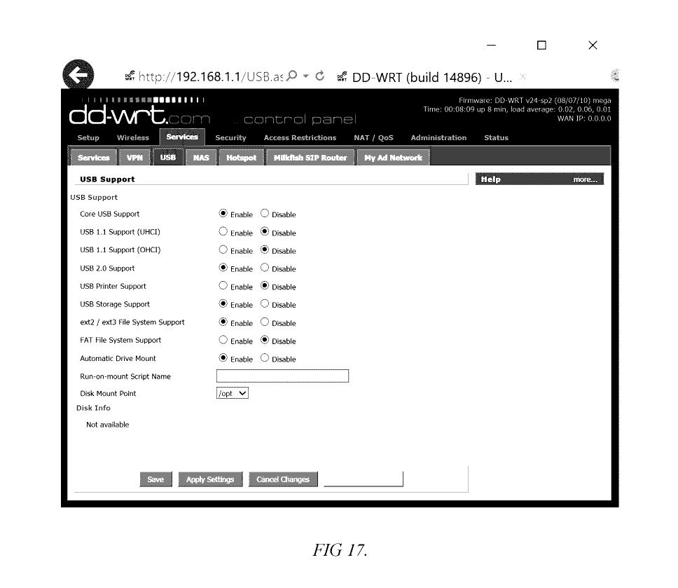

11.2: Click the ‘Enable’ Radio Button that corresponds to the ‘Core USB support’ text. Upon doing so will expand the USB Support field options. Continue selecting the radio buttons as shown in FIG. 17.

11.3: The text field marked “Disk Mount Point” utilize the pull down menu and select ‘/opt’.

11.4: Click the ‘Apply Settings’ button.

### FIG. 17. USB Support Activation

This completes the firmware replacement component of this module.

2. Relocating Web Files Onto the USB Stick

Upon replacing the Asus RT-N16 Wireless Router firmware with the Full DD-WRT Firmware.

The process of hooking up the USB stick (configured in Section 1) and copying the DD-WRT Web server and Web (Binary Blob) file will be outlined in this section.

Step 1:

Using the command “nvram show|grep usb”, will show the current USB variables and settings in use by the DD-WRT Router. In the previous replacement module, these changes were made using the graphical user interface. The FIG. (18) below verifies that the system sees these changes.

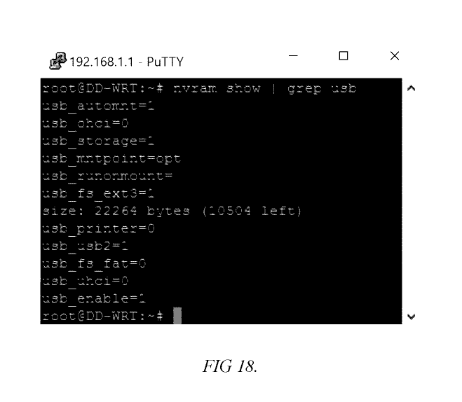

### FIG. 18. Retrieving Current USB Settings from Nvram

Step 2:

2.1 Entering the command “cd /opt” will change the active directory to ‘opt’.

2.2 Entering the command “ls” will display all files and folders currently in the ‘opt’ directory. The USB is mounted to the /opt/ directory. Which at this time will show no files as the USB stick was previously formatted.

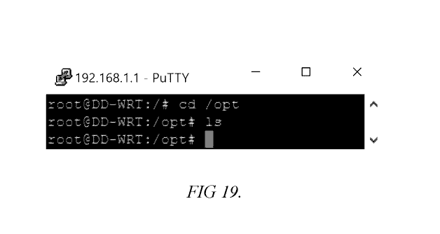

### FIG. 19. Verifying /opt/ Directory (USB Stick) is Empty

Step 3:

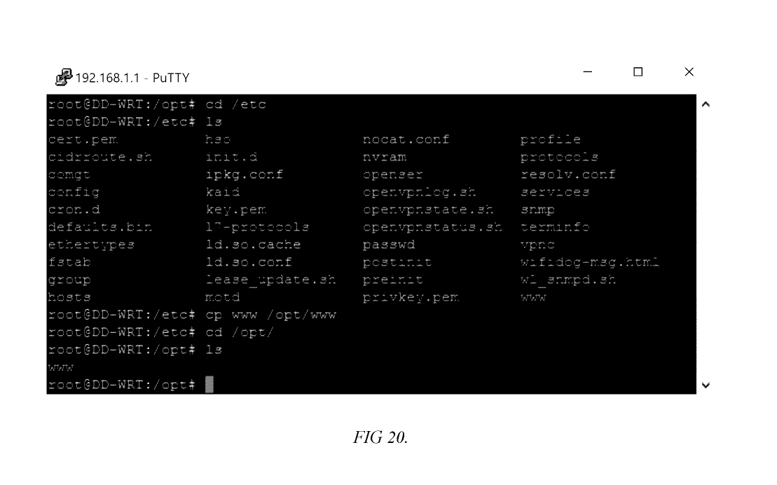

### Refer to FIG. 20 for the Following Sub Steps

3.1: Entering the “cd /etc” command will change directories to the ‘etc’ directory.

3.2: Entering the “ls” command will display all files and folders in the ‘etc’ directory. The file named ‘www’ is the web (binary blob) file. This file is a compiled from an array of underlying web pages and associated files. The concept/technique was created as Webcomp (web compiler) by GoAhead Software. The file is understood by the http server software using a built in Index Array that understands where the start and stop points are for the individual web files that are in the concatenated ‘www’ file.

3.3: Entering the command “cp www /opt/www” copies the ‘www’ file in the ‘etc’ directory to the USB stick which is mounted to the ‘opt’ directory.

3.4: Entering the command “cd /opt/” changes the directory to the ‘opt’ directory, which is actually the mounted USB stick.

3.5: Entering the command “ls” lists all of the files in the directory. Upon doing so, the ‘www’ file is now located on the USB stick.

### FIG. 20. USB: Copying of www File to the USB Stick Mounted to /opt/

Step 4:

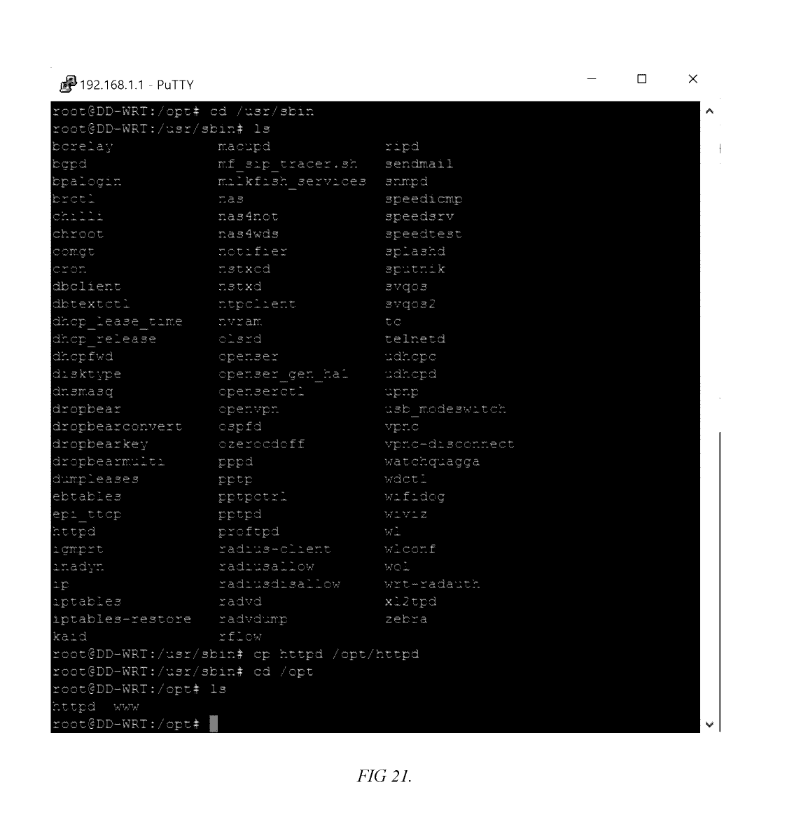

### Refer to FIG. 21 for the Following Sub Steps

The ‘httpd’ file is the actual http web server, as the server provides a simple function it is fully operational as a single stand-alone file. Which can function from any directory when it is moved.

4.1: Entering the command “cd /usr/sbin” changes the directory to the ‘usr/sbin’ directory.

4.2: Entering the command “ls” will list all of the files and folders in the ‘usr/sbin’ directory. The file named ‘httpd’ is the webserver that will need to be copied to the USB stick.

4.3: Entering the command “cp httpd /opt/httpd” copies the ‘httpd’ web server file in the ‘usr/sbin’ directory to the USB stick which is mounted to the opt directory.

4.4: Entering the command “cd /opt/” changes the directory to the ‘opt’ directory, which is actually the mounted USB stick.

4.5: Entering the command “ls” lists all of the files in the directory. Upon doing so, the ‘httpd’ file is now located on the USB stick.

### FIG. 21. USB: Copying of httpd File to the USB Stick Mounted to /opt/

3. Modifying the Firmware Files

This portion of the instruction set will require the use of a Linux operating system. This prototype utilizes Kali Linux to conduct the follow procedure.

Step 1:

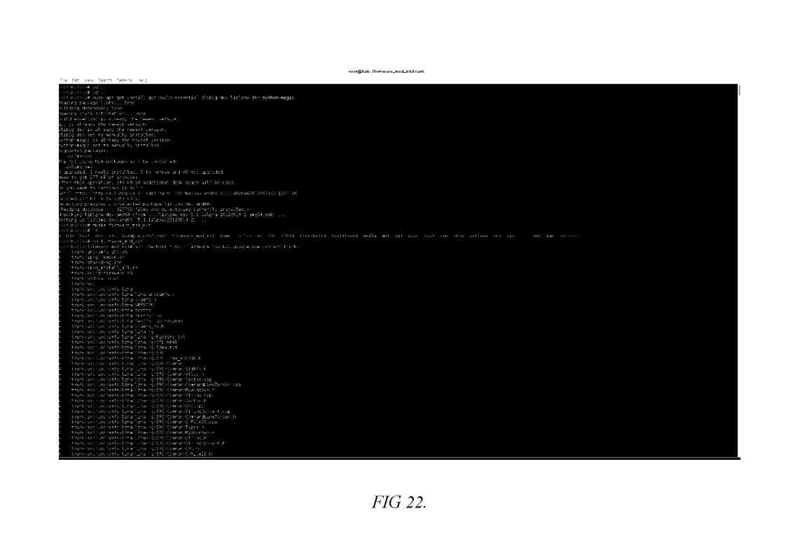

### Refer to FIG. 22 for the Following Sub Steps

1.1: Ensure that the Linux operating system has internet capabilities.

1.2: Open up a command console prompt.

1.3: Entering the command “sudo apt-get install git build-essential zliblg-dev liblzma-dev python-magic” will download and install all of the required packages needed to run the firmware decompiler software. Refer to the FIG. 22 for the process. Once the libraries are installed or updated proceed to step 1.4.

1.4: Entering the command “mkdir firmware_mod_kit” will create a new folder called ‘firmware_mod_kit’.

1.5: Entering the command “ls” will list all of the files and folders. Using this will confirm that there is a folder now named ‘firmware_mod_kit’

1.6: Entering the command “cd firmware_mod_kit” will change the directory to the new ‘firmware_mod_kit’ folder.

1.7: Entering the command “svn checkout https://firmware-mod-kit.googlecode.com/svn/trunk”. This command will download and install the firmware mod kit, which provides the capability of extracting the files within the .bin firmware, so that the internal files can be modified, in addition provides the ability to rebuild the files back into a new .bin firmware file. This process may take a few minutes.

### FIG. 22. Firmware Mod Kit: Downloading and Installing Perquisite Files and FMK Software

Step 2:

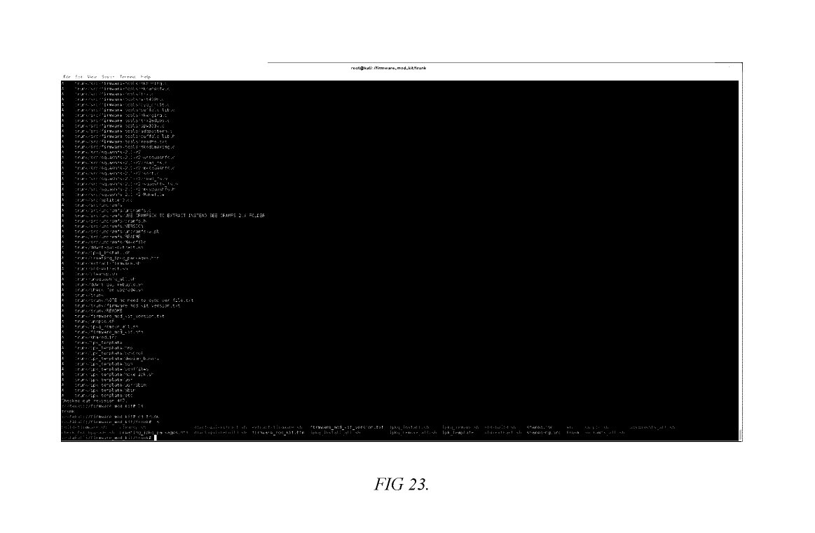

### Refer to FIG. 23 for the Following Sub Steps

Once the ‘firmware_mod_kit’ software has completed its download and installation. The command prompt will be available.

2.1: Entering the command “ls” will list all of the files and directories in the ‘firmware_mod_kit’ directory. The only listing is for a folder named ‘trunk’

2.2: Entering the command “cd trunk” will change the directory to the ‘trunk’ directory.

2.3: Entering the command “ls” will list all of the files and directories in the ‘trunk’ directory. Listed here will be all of the associated files and folders that are part of the ‘firmware_mod_kit’ program.

### FIG. 23. Firmware Mod Kit Install Completion and Verification

Step 3

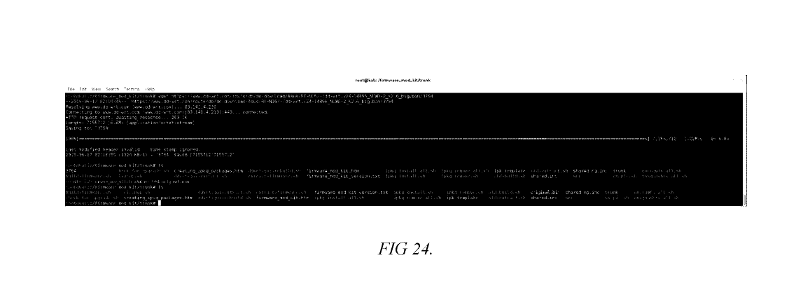

### Refer to FIG. 24 for the Following Sub Steps

This step details the retrieval of the unmodified firmware from the DD-WRT firmware repository.

3.1: Entering the command “wget http://dd-wrt.com/routerdb/de/download/Asus/RT-N16/-/dd-wrt.v24-14896_NEWD-2_K2.6_big.bin/3764” will download the latest official firmware from the DD-WRT firmware repository and the file will be saved as ‘3764’.

3.2: Upon completion of the download, entering the command “ls” will list all of the files and folders in the ‘trunk’ directory, in which now shows the addition of the file ‘3764’

3.3: Entering the command “mv 3764 original.bin” will rename the file ‘3764’ to a standard .bin file that the ‘firmware_mod_kit’ software can utilize.

3.4: Entering the command “ls” will list all of the files and folders in the ‘trunk’ directory, in which now shows the renamed file ‘original.bin’.

### FIG. 24. Downloading Firmware and Renaming

Step 4:

Entering the command “./extract-firmware.sh original.bin” will start the extraction process of the ‘original.bin’ firmware into its individual components comprising of files and folders (the operating system of DD-WRT). This process may take several minutes.

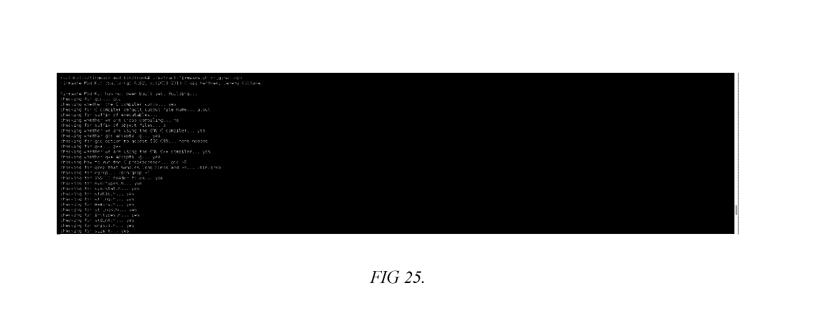

### FIG. 25. Extracting the Operating System from the .bin Firmware File

Step 5:

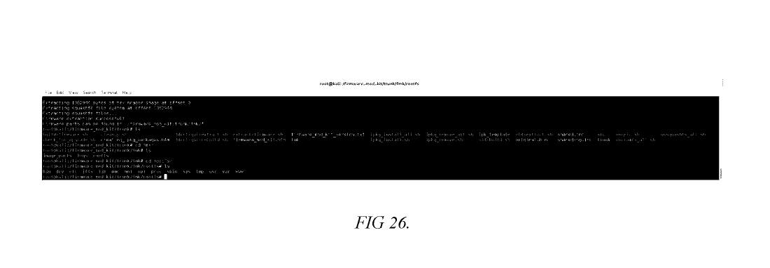

### Refer to FIG. 26 for the Following Sub Steps

Once the extraction process has completed, the software notifies the user that the files are located in the ‘fmk’ directory.

5.1: Entering the command “ls” lists all of the files and folders in the ‘trunk’ directory, of which now lists the ‘fmk’ directory.

5.2: Entering the command “cd fmk/” will change the directory to the ‘fmk’ directory.

5.3: Entering the command “ls” lists all of the files and folders in the ‘fmk’ directory, of which now contains the ‘rootfs’ directory, among others.

5.4: Entering the command “cd rootfs/” will change the directory to the ‘rootfs’ directory.

5.5: Entering the command “ls” lists all of the files and folders in the ‘rootfs’ directory, these files comprise the DD-WRT operating system files.

### FIG. 26. Verification of the Extraction Process

Step 6:

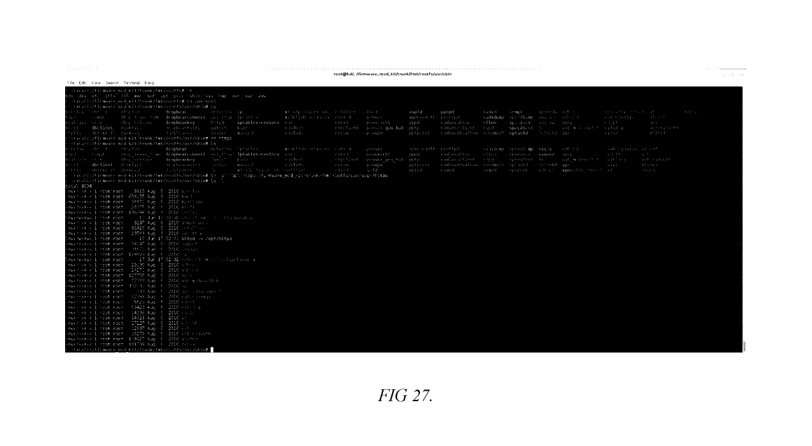

### Refer to FIG. 27 for the Following Sub Steps

This step will remove the web server program ‘httpd’ from the operating system and create a symbolic link otherwise known as a symlink. A symlink is akin to the concept of shortcuts used in Microsoft Windows operating systems. The symlink indicates to the operating system and programs that anytime a call to the ‘httpd’ file is made, believing that the file is located at the ‘/usr/sbin’ directory, will advise the software that the file can be found in the ‘/opt/’ directory, which is the mounted USB stick.

6.1: Entering the command “ls” lists all of the files and folders in the ‘rootfs’ directory, these files comprise the DD-WRT operating system files.

6.2: Entering the command “cd usr/sbin” will change the directory to the ‘usr/sbin’ directory.

6.3: Entering the command “ls” lists all of the files and folders in the ‘usr/sbin’ directory, as seen in FIG. 27, the ‘httpd’ file is present.

6.4: Entering the command “rm httpd” will remove the ‘httpd’ file (the web server) from the operating system/firmware.

6.5: Entering the command “ls” lists all of the files and folders in the ‘usr/sbin’ directory, as seen in FIG. 27, the ‘httpd’ file is no longer present.

6.6: Entering the command “ln-sf /opt/httpd /firmware_mod_kit/trunk/fmk/rootfs/usr/sbin/httpd” will create a symlink (shortcut) file which points to the ‘/opt/httpd’ file which is located on the USB stick.

6.7: Entering the command “ls-l” lists in long form all of the files and folders in the ‘usr/sbin’ directory. Located in FIG. 27, the “httpd→/opt/httpd” symlink has been created.

### FIG. 27. Httpd: Removing the Web Server and Creating the Symlink

Step 7:

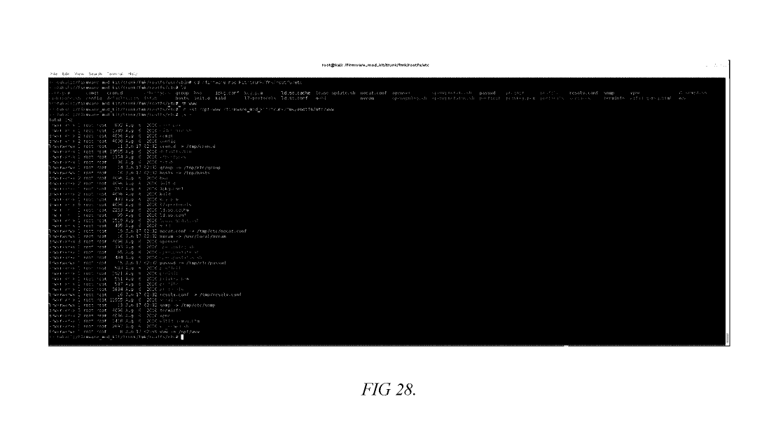

### Refer to FIG. 28 for the Following Sub Steps

This step will remove the ‘www’ (binary blob) file from the operating system and create a symbolic link otherwise known as a symlink. A symlink is akin to the concept of shortcuts used in Microsoft Windows operating systems. The symlink indicates to the operating system and programs that anytime a call to the ‘www’ file is made, believing that the file is located at the ‘/etc/’ directory, will advise the software that the file can be found in the ‘/opt/’ directory, which is the mounted USB stick.

7.1: Entering the command “cd /firmware_mod_kit/trunk/fmk/rootfs/etc/” will change the directory to the ‘etc’ directory.

7.2: Entering the command “ls” lists all of the files and folders in the ‘etc’ directory, as seen in FIG. 28, the ‘www’ file is present.

7.3: Entering the command “rm www” will remove the “‘www’ (the binary blob) file from the operating system/firmware.

7.4: Entering the command “ln-sf /etc/www /firmware_mod_kit/trunk/fmk/rootfs/etc/www” will create a symlink (shortcut) file which points to the ‘/opt/www’ file which is located on the USB stick.

7.5: Entering the command “ls-l” lists in long form all of the files and folders in the ‘etc’ directory. Located in FIG. 28, the “www→/opt/www” symlink has been created.

### FIG. 28. www: Removing the Web Binary Blob File and Creating the Symlink

Step 8:

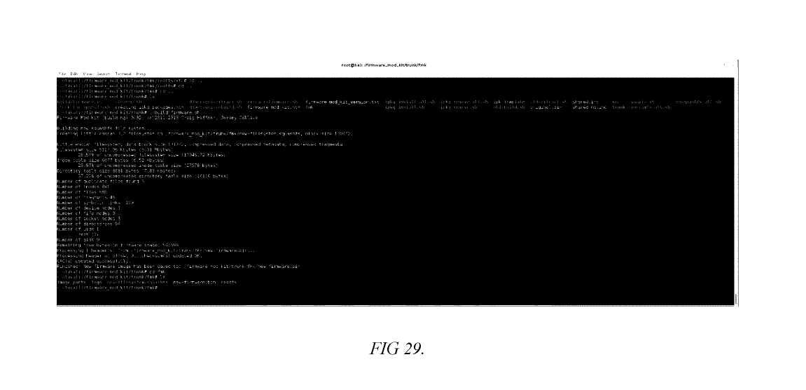

### Refer to FIG. 29 for the Following Sub Steps

At this point, the web server (httpd) and the www (web site files) file have been removed from the operating system and the symlinks (shortcuts) for httpd and www files have been created. The operating system files can now be rebuilt into a .bin firmware file.

8.1: Entering the command “cd . . . ” will change the directory to one level above the current directory. Now placing the ‘/firmware_mod_kit/trunk/fmk/rootfs” as the current directory.

8.2: Entering the command “cd . . . ” will change the directory to one level above the current directory. Now placing the ‘/firmware_mod_kit/trunk/fmk/” as the current directory.

8.3: Entering the command “cd . . . ” will change the directory to one level above the current directory. Now placing the ‘/firmware_mod_kit/trunk/” as the current directory.

8.4: Entering the “ls” command will list all files and folders in the ‘/firmware_mod_kit/trunk/’.

8.5: Entering the command “./build-firmware.sh” command will initiate the rebuilding of the operating system files into a single firmware file, named ‘new-firmware.bin’. This process may take several minutes. Upon completion the system will indicate that the new firmware file can be found in the ‘/firmware_mod_kit/trunk/fmk’ directory.

8.6: Entering the command “cd fmk” will change the directory to the ‘/firmware_mod_kit/trunk/fmk/’ directory.

8.7: Entering the “ls” command will list all files and folders in the ‘/firmware_mod_kit/trunk/fmk’. Within the listing, one can note the addition of the ‘new-firmware.bin’ file.

### FIG. 29. Rebuilding the New Modified Firmware File

This concludes the instruction set for extracting, modifying and rebuilding of the firmware into a customized firmware that removes the web server and associate file from the operating system and creates symlinks (shurtcuts) that points any system calls to these files to the USB stick.

4. Loading the Custom Offboarding Firmware

Having replaced the Asus stock firmware with the DD-WRT Mini Firmware and then replacing it with the Full DD-WRT Firmware, the following instruction set will detail the process of replacing the Full DD-WRT Firmware with the customized OffBoarding Firmware.

Step 1:

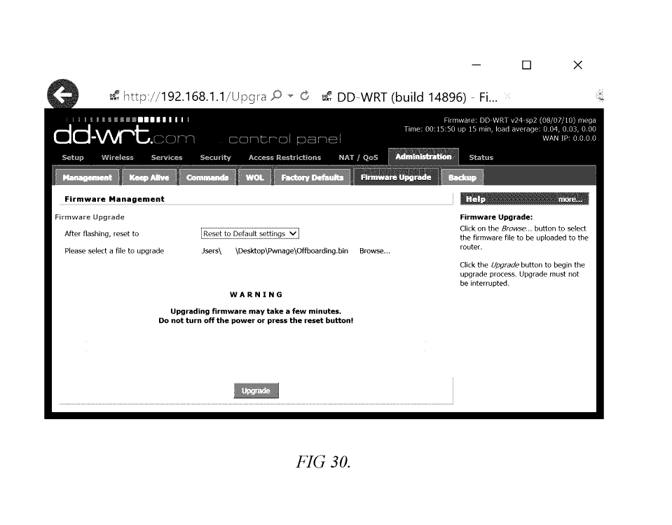

### Refer to FIG. 30 for the Following Sub Steps

1.1: Locate the ‘Administration’ Tab. Click the ‘Administration’ Tab.

1.2: Locate the ‘Firmware Upgrade’ Tab. Click the ‘Firmware Upgrade’ Tab.

1.3: At the Selection “After flashing, reset to” pull down menu, ensure that the selection is set to “Reset to Default settings:

1.4: Click the ‘Browse’ button and select the firmware that was saved to the desktop named ‘Offboarding.bin’. Or using the Linux web browser conduct the firmware loading, else copy the firmware from the previous section step 8, to the Windows desktop.

1.5: Press the ‘Upgrade’ Button.

### FIG. 30. Prepping the Upgrade of the Offboarding Custom Firmware

Step 2:

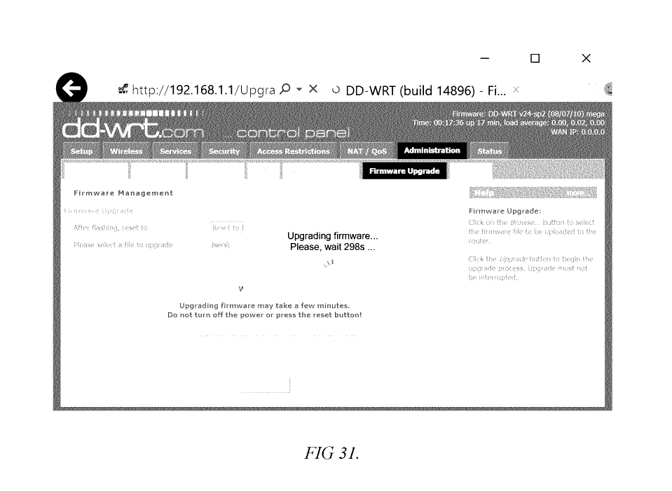

Upon pressing the ‘Upgrade” button the new custom Offboarding firmware will be loaded and replacing the Full DD-WRT Firmware as seen in FIG. 31, several minutes are required to complete the process.

### FIG. 31. Upgrading the Firmware Progress Screen

Step 3:

Utilizing the operating systems Ping utility, in this case Windows 10 Ping.exe. Begin to continuously pinging the IP address of the router using the command “192.168.1.1-t”.

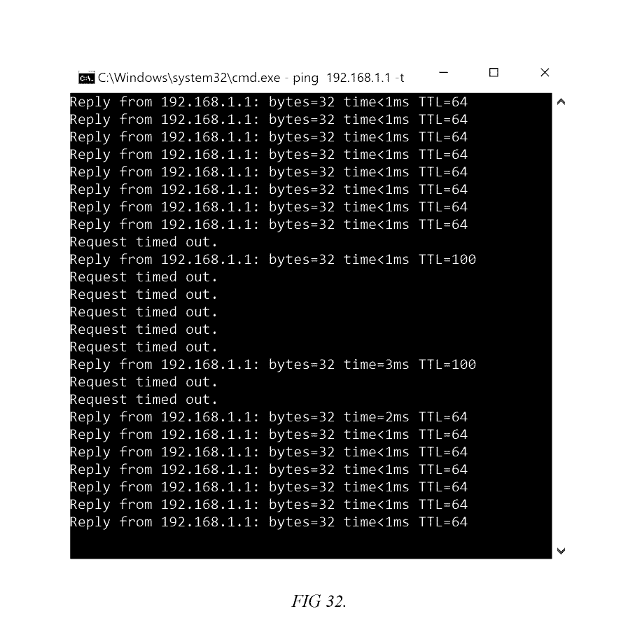

As the router reboots, the ping utility will indicate the down, reboot and up status of the router. When pings begin to resume ping backs. The router is back online. Refer to FIG. 32 for an example.

### FIG. 32. Ping Status of the Router During the Upgrade Process

Step 4:

By default, SSH is not enabled and due to the custom firmware, the built in web server is no longer functioning/available. The only method to connect to the Router's operating system is through Telnet.

4.1: Utilizing a telnet program, in this case putty.exe was used. Set the IP address as ‘192.168.1.1’ and select the ‘telnet’ Radio Button, then click the ‘Open’ Button.

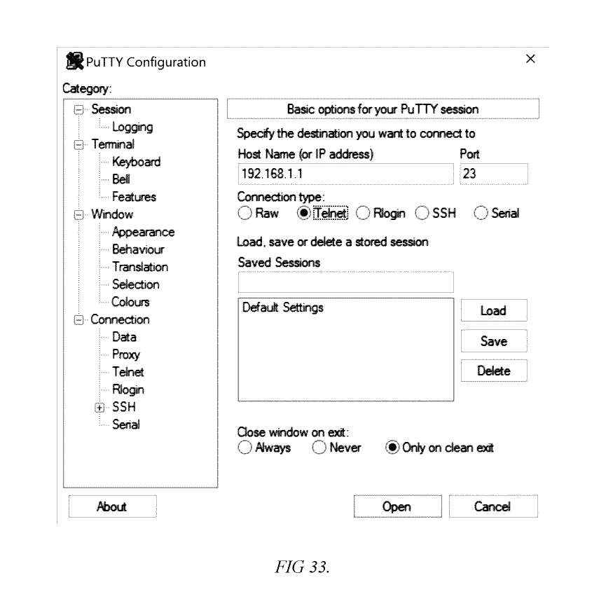

### FIG. 33. Telnet: Putty.exe Settings

Step 5:

Upon clicking the ‘Open’ Button in Putty.exe, the user will be presented with the Custom DD-WRT login screen and require credentials. Using “root” as the username and “admin” as the password, continue to log in.

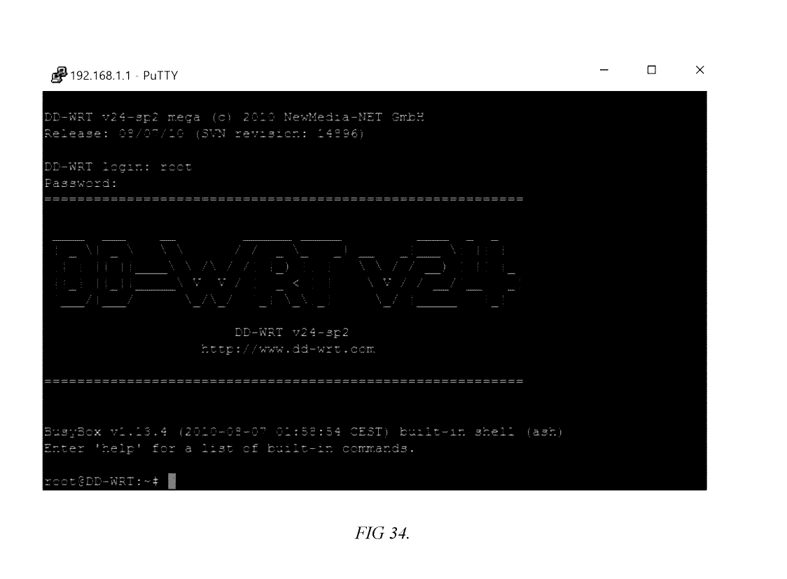

### FIG. 34. Logging into the Custom DD-WRT using Telnet

Step 6:

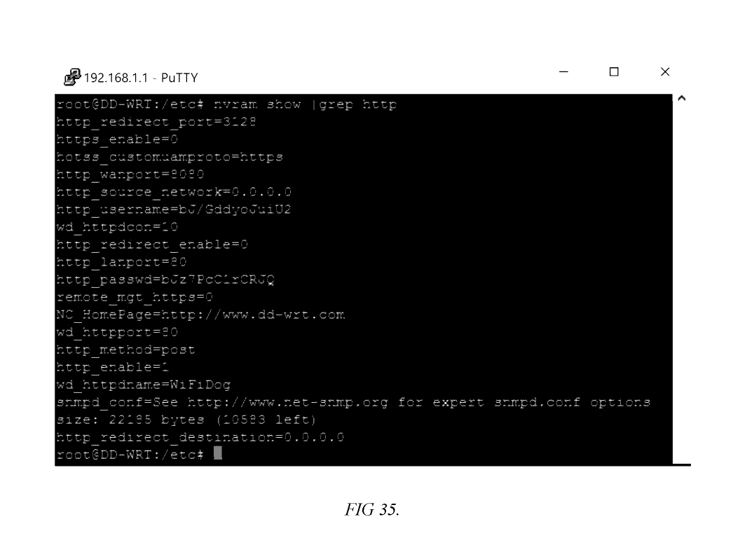

### Refer to FIG. 35 for the Following Sub Steps

At the command prompt type in “nvram show|grep http” and press enter.

This command will retrieve all parameters in the 1303 variable configuration settings file that contain http in their variable/setting name.

NOTE: The 1303 variables/settings in the configuration file dictate to the router what features to initiate upon reboot or power on.

In reviewing FIG. 35, the variable ‘http_enable=1’, indicates that the http server will be called to be active during a reboot cycle or powering on of the device.

### FIG. 35. Verification of the http Settings within the Nvram Configuration File

Step 7:

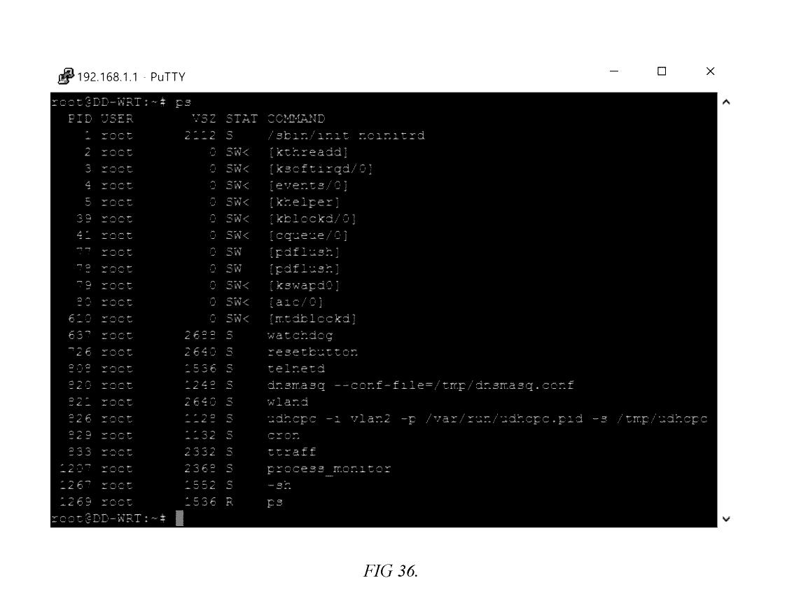

### Refer to FIG. 36 for the Following Sub Steps

At the command prompt type in “ps” and press enter.

The ‘ps’ command will list all active process currently running on the system. As noted in FIG. 36, there is no http service running. This is expected at this stage of the instruction set.

### FIG. 36. Verification that the httpd Process is not Running

5. Integrating the Custom Firmware

After installing the new custom firmware, some initial integration steps need to be completed. Once these are done the system will function as designed, with the web server and all associated files operating from the USB.

By default USB Support is not enabled. The following procedures will verify the removal of the web server and files from the onboard custom firmware and show that the http services will not run until the USB Activation settings are configured, that the proper changes were made to the firmware to instruct the firmware where to find the files from the USB stick.

Step 1:

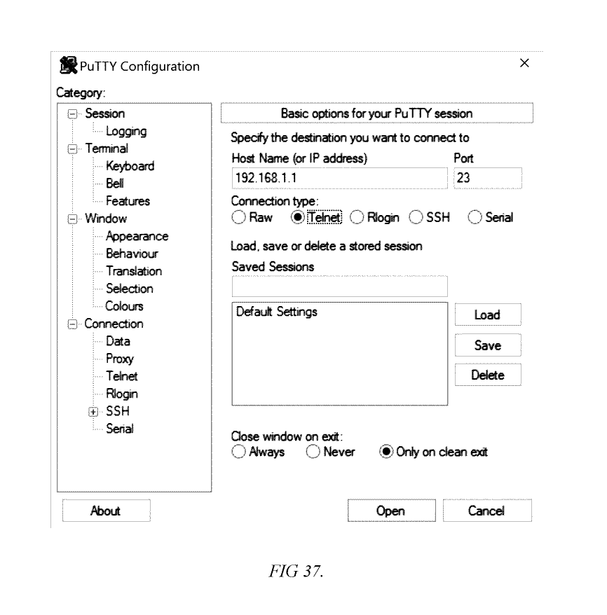

### Refer to FIG. 37 for the Following Sub Steps

Plug in the USB stick, which should now contain the ‘httpd’ and ‘www’ files. While the USB is plugged in the files are not yet accessible.

Step 2:

By default, SSH is not enabled and due to the custom firmware the built in web server is no longer functioning. The only method to connect to the Router's operating system is through Telnet.

2.1: Utilizing a telnet program, in this case putty.exe was used. Set the IP address as ‘192.168.1.1’ and select the ‘Telnet’ Radio Button, then click the ‘Open’ Button.

### FIG. 37. Telnet: Putty.exe Settings

Step 3:

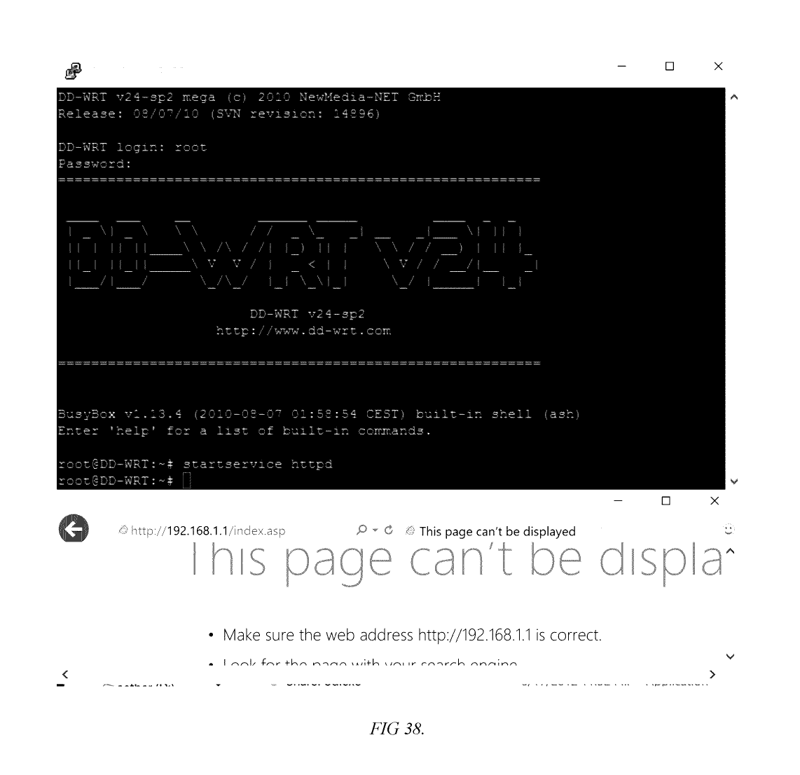

### Refer to FIG. 38 for the Following Sub Steps

3.1: Upon clicking the ‘Open’ Button in Putty.exe, the user will be presented with the Custom DD-WRT login screen and require credentials. Using “root” as the username and “admin” as the password, continue to log in.

3.2: Start a web browser and use the router's default IP address of http://192.168.1.1. The webpage should fail to load as seen in FIG. 38.

3.3: Entering the command “startservice httpd” will manually activate the web server ‘httpd’ program.

Because the ‘httpd’ and ‘www’ files are not on the router anymore and the USB is currently disabled, the call to start the ‘httpd’ server will not work.

3.4: Refreshing the web browser page will continue to yield no response.

### FIG. 38. Manual Start of the httpd Service and Verification the Service will not Start

Step 4.

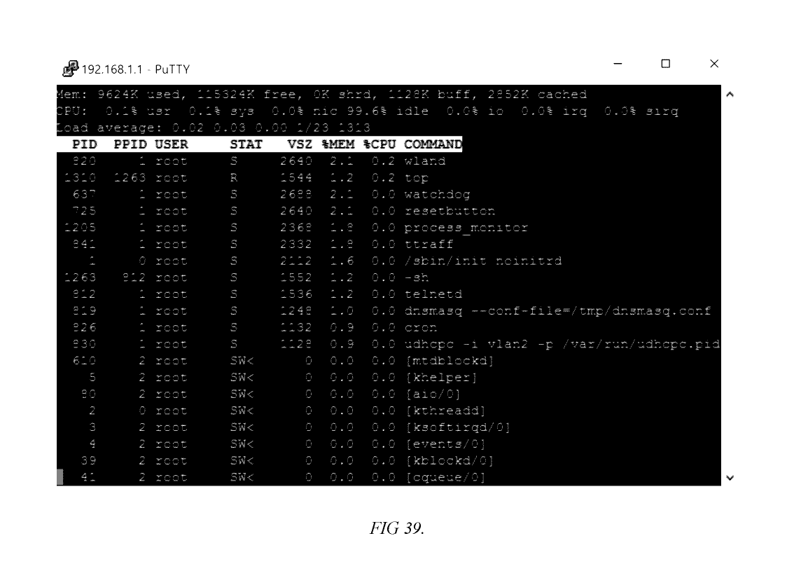

Entering the command “ps” will show all current running processes on the router. The web server ‘httpd’ is not present as it is currently not accessible as seen in FIG. 39.

### FIG. 39. Verification that the httpd Service is not Running

Step 5:

NOTE: When USB support is activated, the USB Stick will mount to the ‘opt’ directory, until then the ‘opt’ directory is present but nothing from a connected USB will be available.

5.1: Entering the command “cd /opt” changes the directory to the opt directory.

5.2: Entering the command “ls” lists all of the files in the opt directory, which shows no files present.

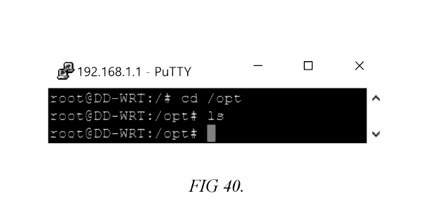

### FIG. 40. Verifying that the ‘opt’ Directory is Empty

Step 6:

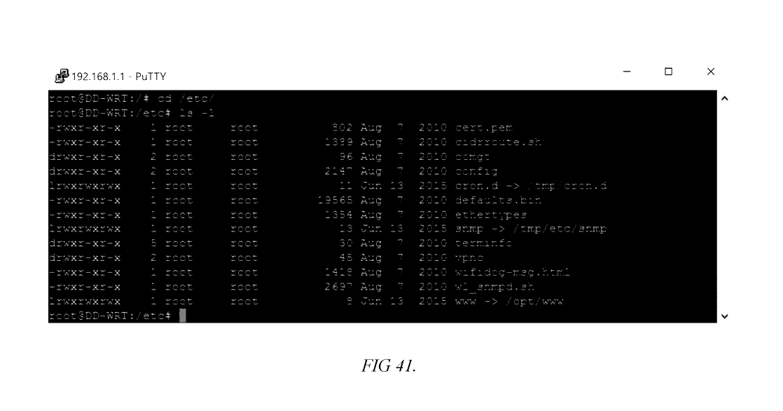

### Refer to FIG. 41 for the Following Sub Steps

6.1: Entering the command “cd /etc/” changes the directory to the ‘etc’ directory.

6.2: Entering the command “ls-l” lists all of the files and folders in the ‘etc’ directory. The “-l” switch refers to the Long format, it provides more detail about the properties of the files within the directory.

Of interest is the listing for “www→/opt/www” in light blue in addition to the file properties of “lrwxrwxrwx” this indicates that the file ‘www’ is a Link, otherwise known as a symbolic link or symlink for short. It is similar to a shortcut file in Microsoft Windows systems. “www→/opt/www” tells the operation system what whenever any program or calls to the www shortcut, that is being expected to reside in the ‘etc’ directory, it will refer the calling program to find the file in the ‘opt’ directory, which is mounted to the USB stick.

### FIG. 41. Verifying the Presence of the Symlink for the www (Binary Blob) File

Step 7:

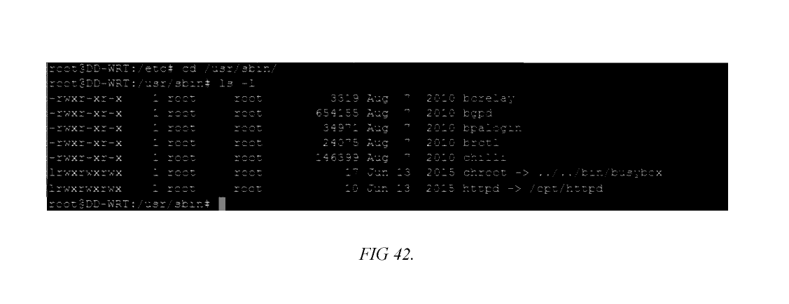

### Refer to FIG. 42 for the Following Sub Steps

7.1: Entering the command “cd /usr/sbin” changes the directory to the ‘/usr/sbin’ directory.

7.2: Entering the command “ls-l” lists all of the files in the ‘/usr/sbin’ directory. Here the listing shows that the shortcut file ‘httpd’ is symlinked to the /‘opt/’ directory. ‘Httpd’ actually resides on the USB stick that is mounted on the ‘opt’ directory.

### FIG. 42. Verifying the Presence of the Symlink for the httpd (Web Server) File

Step 8:

At this stage the web server httpd and the www files are currently on the USB stick, which is current inactive. It has been shown above that those two files do not exist on the router but are linked/shortcutted to point to the USB stick. This next step will activate the USB stick and in turn complete the symlinks which will allow the Web Server HTTPD to run.

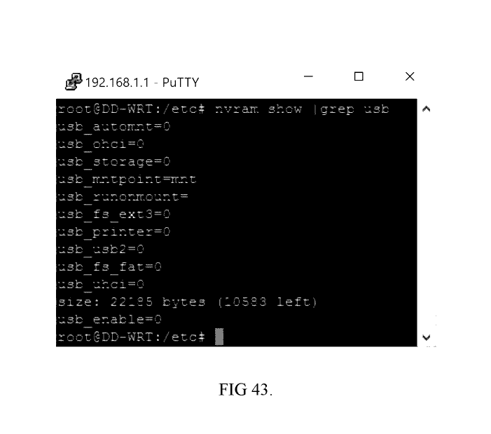

8.1: Entering the command “nvram show|grep usb” will retrieve a parsed list of all USB variables with in the 1303 variable nvram settings file. As seen FIG. 43 most of the USB variables are inactive and set to 0.

### FIG. 43. Verifying USB Settings are Inactive

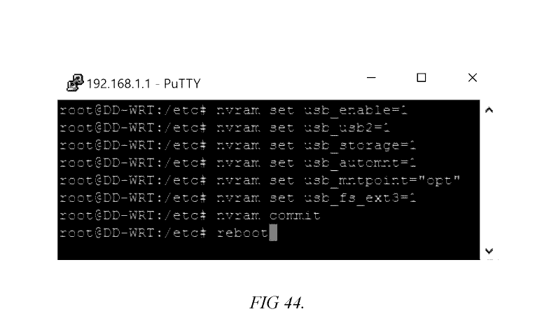

8.2: Using the commands listed in FIG. 44, will set these parameters to activate USB Support capabilities of the router. These commands begin with the command “nvram set”

8.3 After setting the variables, entering the command “nvram commit” saves the nvram file and the changes made.

8.4: Entering the “reboot” command reboots the router.

### FIG. 44. Setting the USB Variables, Saving the Settings and Rebooting the Router

Step 9:

9.1: After the router has rebooted. Using Putty.exe and reconnect a telnet session to the router.

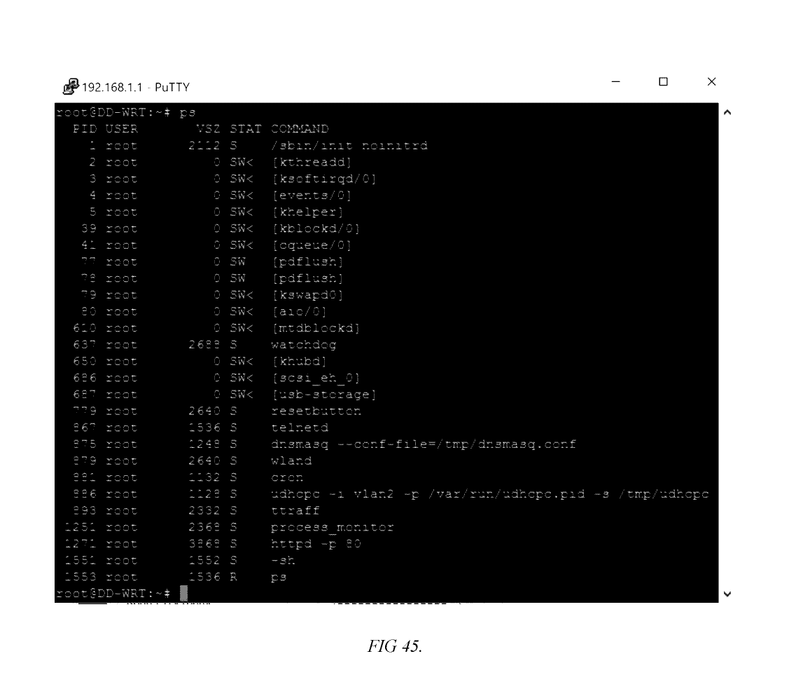

9.2: Entering the “ps” command will show all current process and programs running on the router, of note, httpd the web server is now running as indicated in FIG. 45.

### FIG. 45. Verification of the httpd Process is Running

Step 10:

After activating the USB stick, rebooting the router, and verifying the httpd process is running, the following steps will show that the web server is indeed running and that configuration changes can be made and saved.

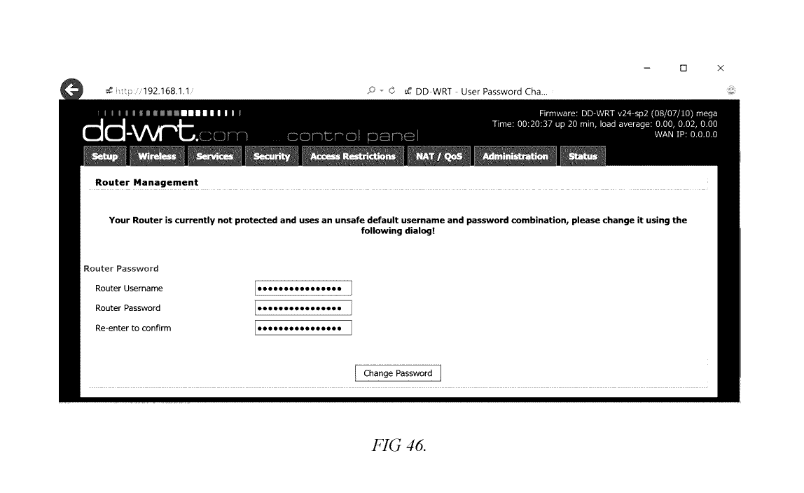

### Refer to FIG. 46 for the Following Sub Steps

10.1: Start a web browser and use the router's default IP address of http://192.168.1.1. The webpage should load and be ready for use.

10.2: Create a user name (admin) and password. Click the ‘Change’ Password button.

### FIG. 46. Verification of a Working Administrative Web Console

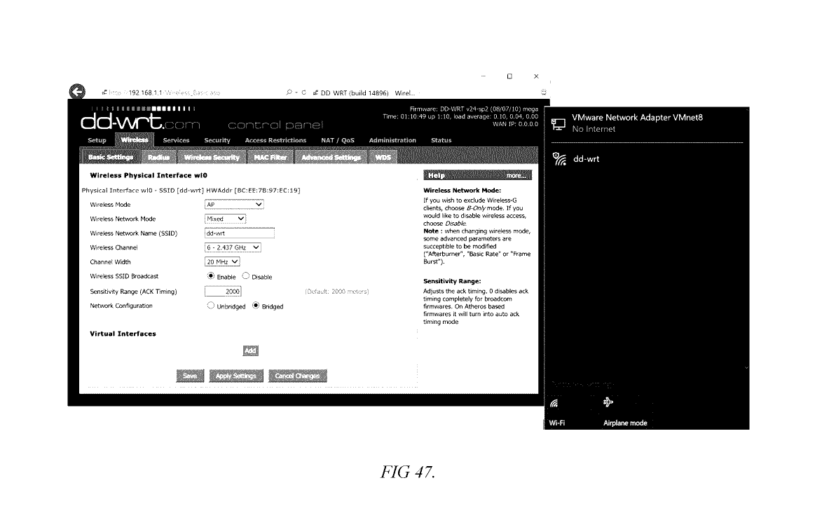

### Refer to FIG. 47 for the Following Sub Steps

10.3: Locate and click the ‘Wireless’ Tab.

10.4: Find the written text ‘Wireless Network Name (SSID)’.

10.5: Using the Microsoft Windows Wireless connection tool to display current wireless signals. As shown in the FIG. below, the computer detects a wireless signal called ‘dd-wrt’, which matches the SSID listed in the router's web page.

### FIG. 47. Verifying the Computer's Wireless Adapter Sees the Current SSID Configured in the Router

10.6: The Wireless Network Name (SSID) is changed from “dd-wrt” to “offboarding”. After clicking the “Apply Settings” Button, the change can be verified by using the computer's wireless connection tool.

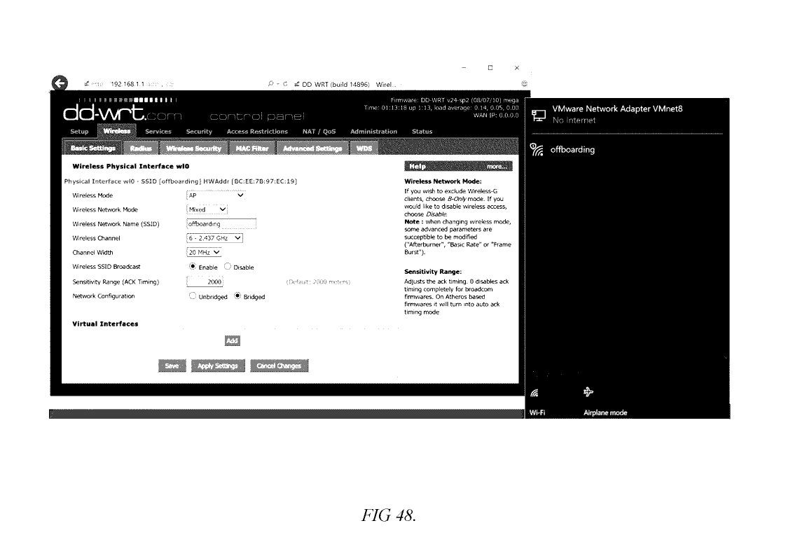

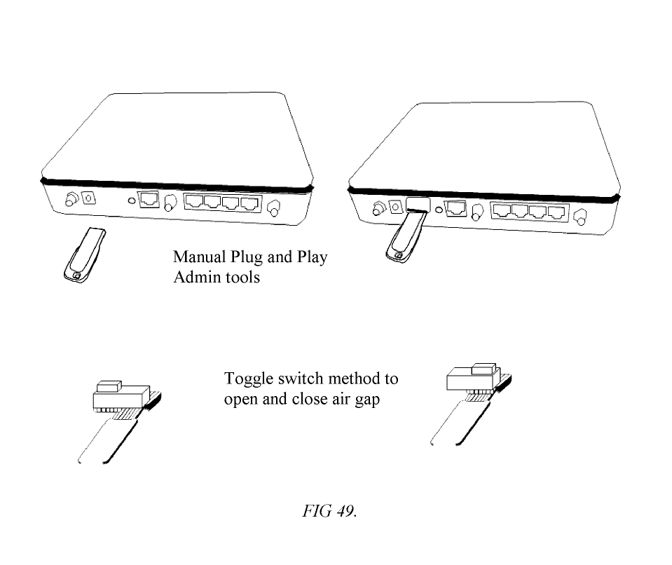

### FIG. 48. Verification that Custom Firmware is Able to Take and Save Changes

The above-described steps can be altered and/or supplemented with other technologies for particular implementations. For instance, in some embodiments, rather than offboard the web based admin console of a wireless router, one could offboard, the telnet server, SSH server or all administrative tools. One could easily apply the offboarding concept to a web based admin console of a network printer, IP phone, IP security cam, home automation devices like web enabled heating system, web enabled fridge or tv, as well as other IP enabled devices such as SCADA/ICS devices, medical IP enabled devices. While this prototype focuses on offboarding services for embedded IP enabled devices, it can be applied to always on full commercial websites, juggling offboarding administrative modules, code libraries, security keys, accounts, data stores and much more.

Although the present invention has been described with reference to preferred embodiments, workers skilled in the art will recognize that changes may be made in form and detail without departing from the spirit and scope of the invention.

1. The present invention seeks introduce the concept (and method of doing so via a prototype) of air gapping software or offboarding software to another data storage device, a working prototype will demonstrate this capability. Applicable to any Internet/network capable device that utilizes internal or on board administrative tools in order for the device to be configured. This implementation comprising:
Modifying or (creating a new operating system) the underlying operating system;
Copying the administrative tools from the onboard data storage device to an offboard data storage device;
Extracting (decompiling) the operating system (firmware) from the IP enabled device, modifying the underlying files by removing the administrative tools and creating links, such as symlinks, symbolic links, shortcuts or any form of referral commands found open and proprietary systems that direct the devices/software making function or calls to the administrative tools, expecting to find it in the onboard data storage device to be redirected to the offboard data storage device;
Off board storage devices are those that can be physically disconnected and reconnected to the primary IP enabled device to which the administrative tools were on;
Recompiling the modified operating system or firmware software;
Reloading the new modified operating system or firmware;
Connecting the offboard data storage devices containing the administrative software
This method allows for transparent operation of the administrative tools in that the user, the operating system and the software are not aware that there is any software based air gapping or offboarding going on.
Any air gapped software residing on the offboard data storage device that the user does not require, simply disengaging the offboard storage device manually or automatically will remove the administrative software or any software from any potential threat vectors. The administrative tools and other software are available when needed and an air gap is created from the mainboard when not needed.

2. The software based air gapping method of claim 1 further considers that the term data storage device encompasses disk based hard drives, solid state hard drives, RAM, ROM, EEPROM, nvram, volatile, USB sticks/hard drives, DVDs, CDs, Tape drives, mechanical storage devices, electrical storage devices, optical storage devices, flash memory storage devices, in additional to any future storage devices to be used in computing devices (quantum, crystalline, DNA storage devices) or device considered a computer readable storage medium.

3. The software based air gapping method of claim 1 further considers the term internet/network capable devices to be any device that is able to communicate over what is commonly known as the internet, intranet, Internet and or utilizes network protocols to communicate with other IP enabled devices, ie switches, routers, network appliances, IP phones, home automation devices, SCADA/ICS, Internet of Things and others.

4. The software based air gapping method of claim 1 considers the term physical separation to mean electrical, optical, magnetic and physical means, using automated or manual methods that facilitate separation.

5. The software based air gapping method in claim 1 considers the term/act of reconnection to mean reconnecting the offboard storage devices in claim 2 to the IP enabled devices in claim 3 by means of electrical, optical, magnetic and physical procedures, using automated or manual methods.

6. The software based air gapping method in claim 1 considers the automated methods of claim 4 and 5 to mean the use of automated electrical or software based relays or circuits to provide the reconnections that connect the offboard data storage device to the IP enabled device.

7. The automated methods in claim 4 considers reconnection methods to be achieved by electrical and software based signals that instruct the relays, switches, circuits, timer circuits or software based timers to, disengage and break the connection between the devices listed in claim 2 from those in claim 3.

8. The manual methods of separation in claim 4 and claim 5 refer to the manual methods of separation such as the use of toggle, dip and any other similar devices, in addition to the hand pulling and insertion of the device.

9. The software based air gapping method in claim 1 considers offboarding or air gapping to mean devices that can be externally connected by a pre-existing port (USB, Ethernet, console) or internally by, soldering a port to the internal device's (claim 3) circuit board using jtags, serial connections, serial ports (RS232), UART ports, USB unused points onboard, serial peripheral interfaces, DebugWire, PDI, parallel printer ports and any other circuit board connections (soldering wires to the printed circuit board, traces, jumpers.

10. The software based air gapping method in claim 1 considers offboarding or air gapping applicable for closed proprietary operating systems, firmware and devices as well as open operating systems firmware and devices.

11. The software based air gapping method in claim 1 can further be applied to always-on full commercial web applications, offboarding important services, files, libraries, accounts, code modules and such.
